(19) United States
(12) Patent Application Publication
(10) Pub. No.: US 2007/0152612 A1
(43) Pub. Date: Jul. 5, 2007

(54) Motor controller

(75) Inventors: Chien-Jung Chen, Kaohsiung Hsien (TW); I-Rong Liang, Kaohsiung Hsien (TW)

Correspondence Address: DAVIDSON BERQUIST JACKSON & GOWDEY LLP, 4300 WILSON BLVD., 7TH FLOOR, ARLINGTON, VA, 22203, US

(73) Assignee: YEN SUN TECHNOLOGY CORP.

(21) Appl. No.: 11/438,329

(22) Filed: May 23, 2006

(30) Foreign Application Priority Data
Dec. 30, 2005 (TW) 094147508

(51) Int. Cl. H02P 1/00; H02P 3/00

(52) U.S. Cl. 318/280

(57) ABSTRACT

A motor controller includes a power source unit providing a direct current output, a drive unit including a drive coil, first and second transistor units, a voltage drop component, and a processor. The transistor units are coupled to the power source unit and the drive unit, and enable electricity to flow through the drive coil in a first direction when the first and the second transistor units are in conducting and non-conducting states respectively, and in an opposite second direction when the first and the second transistor units are in non-conducting and conducting states respectively. The voltage drop component has a first end coupled to the drive unit and a grounded second end. The processor is coupled to a junction of the drive unit and the voltage drop component, and provides first and second pulse-width-modulated signals to the first and second transistor units, respectively.

### CROSS-REFERENCE TO RELATED APPLICATION

This application claims priority of Taiwanese application no. 094147508, filed on Dec. 30, 2005.

### BACKGROUND OF THE INVENTION

1. Field of the Invention

The invention relates to a controller for a brushless direct current motor, more particularly to a motor controller that is capable of precise speed adjustment using pulse width modulation (PWM) techniques.

2. Description of the Related Art

In a conventional brushless direct current motor, when electricity is conducted through a stator coil, a Hall IC is adopted to determine the positions of north and south poles of a magnetic rotor so that the direction of current flow through the stator coil can be varied to generate an alternating magnetic field, thus producing magnetic repulsive forces to cause continuous rotation of the magnetic rotor. Moreover, pulse width modulation (PWM) is a common technique used for speed control of a motor, such as a fan motor.

As shown in FIG. 1, a conventional controller 1 utilizes two pulse-width-modulated (PWM) signals (A), (B) to control alternating activation and deactivation of four transistor switches 11 to 14. For example, when the PWM signal (A) is at a high logic state to cause the transistor switches 11, 12 to conduct, and the PWM signal (B) is at a low logic state to cut-off the transistor switches 13, 14, the current in the coil 15 flows in the direction indicated by the solid arrow line in FIG. 1. On the other hand, when the PWM signal (B) is at a high logic state to cause the transistor switches 13, 14 to conduct, and the PWM signal (A) is at a low logic state to cut-off the transistor switches 11, 12, the current in the coil 15 flows in the direction indicated by the dotted arrow line in FIG. 1. Motor speed control is made possible by controlling the switching frequency of the direction of current flow through the coil 15.

However, a back electromotive force effect is likely to occur at the instant the direction of current flow through the coil 15 is switched, which can lead to erroneous operation of the transistor switches 11 to 14 and which can result in possible damage to the transistors switches 11 to 14 and the motor.

FIG. 2 illustrates another conventional motor controller 3 that comprises a pair of first transistor switches 31, a pair of second transistor switches 33, and first and second control circuits 32, 34. In use, when a first pulse-width-modulated (PWM) signal (C) is at a low logic state to cut-off the first transistor switches 31, a second PWM signal (D) drives transistors 321 of the first control circuit 32 to lock the first transistor switches 31 at the cut-off state. Likewise, when a third PWM signal (E) is at a low logic state to cut-off the second transistor switches 33, a fourth PWM signal (F) drives transistors 341 of the second control circuit 34 to lock the second transistor switches 33 at the cut-off state. In this way, erroneous operation of the transistors switches 31, 33 due to back electromotive force occurring at the instant the direction of current flow through a motor coil 37 is switched can be minimized.

Nevertheless, the back electromotive force effect is still likely to interfere with operation of the transistors 321, 341 of the first and second control circuits 32, 34 such that erroneous operation of the transistor switches 31, 33 cannot be entirely avoided.

### SUMMARY OF THE INVENTION

Therefore, the object of the present invention is to provide a motor controller which utilizes a processor to detect a change in voltage drop when the direction of current flow through a drive coil is switched, and which further utilizes pulse-width-modulation techniques to accurately control conduction and non-conduction of transistors in order to achieve precise speed adjustment for brushless direct current motors.

According to the present invention, a motor controller comprises a power source unit, a drive unit, first and second transistor units, a voltage drop component, and a processor. The power source unit provides a direct current output. The drive unit includes a drive coil. The transistor units are coupled electrically to the power source unit and the drive unit, and enable electric current to flow through the drive coil in a first direction when the first transistor unit is in a conducting state and the second transistor unit is in a non-conducting state, and in a second direction opposite to the first direction when the second transistor unit is in a conducting state and the first transistor unit is in a non-conducting state. The voltage drop component has a first end coupled electrically to the drive unit and a grounded second end. The processor has a detecting terminal coupled electrically to a junction of the drive unit and the voltage drop component, a first output terminal coupled electrically to the first transistor unit, and a second output terminal coupled electrically to the second transistor unit. The processor detects a voltage drop at the junction via the detecting terminal, provides a first pulse-width-modulated signal to the first transistor unit via the first output terminal, and simultaneously provides a second pulse-width-modulated signal to the second transistor unit via the second output terminal. The second pulse-width-modulated signal is an inverted form of the first pulse-width-modulated signal. The processor provides the first and second pulse-width-modulated signals to cause the first and second transistor units to operate in the conducting and non-conducting states in an alternating manner according to change in the voltage drop detected at the junction.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic electric circuit diagram of a conventional controller for a brushless direct current motor;

FIG. 2 is a schematic electric circuit diagram of another conventional motor controller; and

FIG. 3 is a schematic electric circuit diagram of the preferred embodiment of a motor controller according to the present invention.

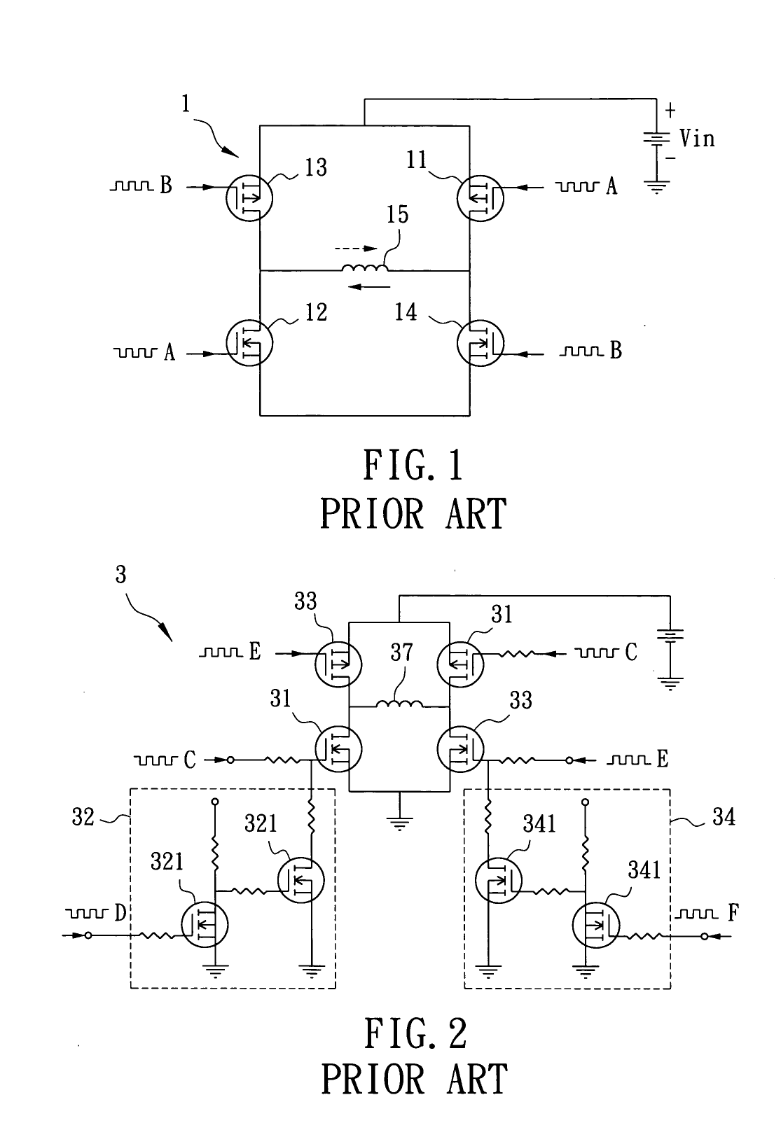

### DETAILED DESCRIPTION OF THE PREFERRED EMBODIMENT

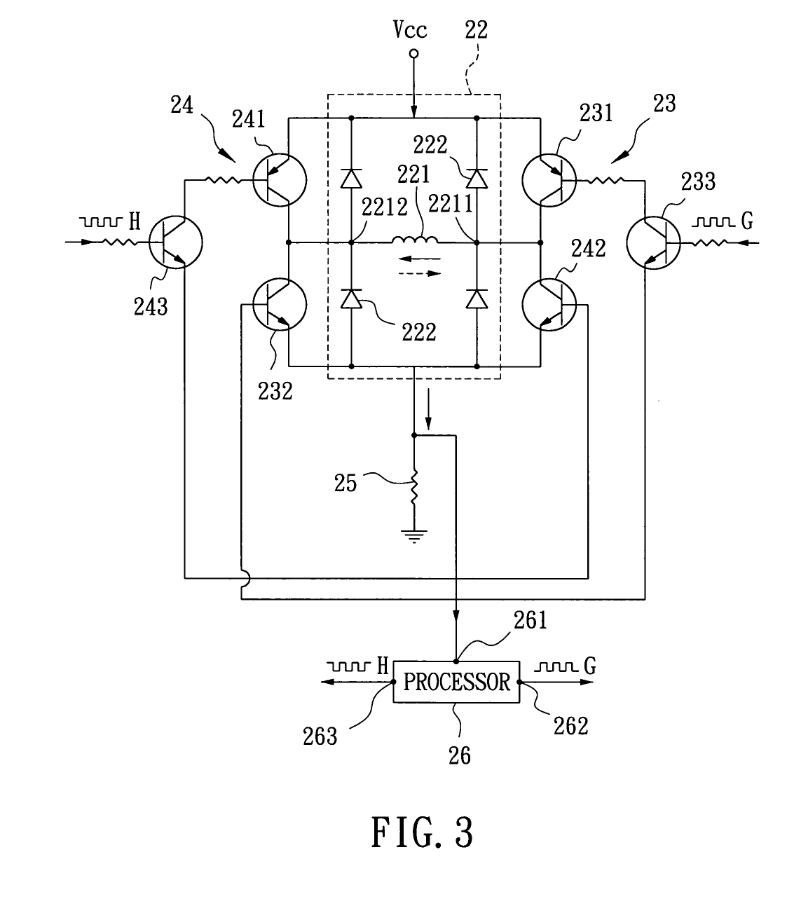

Referring to FIG. 3, the preferred embodiment of a motor controller 2 according to the present invention is adapted for driving rotation of a magnetic rotor (not shown) of a brushless direct current motor, and is shown to include a power source unit (Vcc) for providing a smooth and stable direct current output, a drive unit 22, first and second transistor units 23, 24, a voltage drop component 25, and a processor 26.

The drive unit 22 is coupled electrically to the power source unit (Vcc), and includes a drive coil 221 (which is wound on a stator of the motor), a first set of diodes 222 coupled electrically and respectively between opposite ends 2211, 2212 of the drive coil 221 and the power source unit (Vcc), and a second set of diodes 222 coupled electrically and respectively between the opposite ends 2211, 2212 of the drive coil 221 and the voltage drop component 25. The diodes 222 cooperate with the drive coil 221 to form an H-bridge configuration, and serve to protect the drive coil 221 from burnout due to reverse current flow.

The first and second transistor units 23, 24 are coupled electrically to the power source unit (Vcc) and the drive unit 22, and enable electric current to flow through the drive coil 221 in a first direction (as indicated by a solid arrow line in FIG. 3) when the first transistor unit 23 is in a conducting state and the second transistor unit 24 is in a non-conducting state, and in a seconddirection (as indicated by a dotted arrow line in FIG. 3) opposite to the first direction when the second transistor unit 24 is in a conducting state and the first transistor unit 23 is in a non-conducting state.

The voltage drop component 25 has a first end coupled electrically to the drive unit 22 and a grounded second end. In this embodiment, the voltage drop component 25 is a resistor.

The processor 26 has a detecting terminal 261 coupled electrically to a junction of the drive unit 22 and the voltage drop component 25, a first output terminal 262 coupled electrically to the first transistor unit 23, and a second output terminal 263 coupled electrically to the second transistor unit 24.

In this embodiment, the first transistor unit 23 includes a first transistors coupled between the power source unit (Vcc) and the first end 2211 of the drive coil 221, a second transistor 232 coupled between the voltage drop component 25 and the second end 2212 of the drive coil 221, and a third transistor 233 coupled between the first and second transistors 231, 232 and further coupled to the first output terminal 262. The second transistor unit 24 includes a fourth transistor 241 coupled between the power source unit (Vcc) and the second end 2212 of the drive coil 221, a fifth transistor 242 coupled between the voltage drop component 25 and the first end 2211 of the drive coil 221, and a sixth transistor 243 coupled between the fourth and fifth transistors 241, 242 and further coupled to the second output terminal 263. The first and fourth transistors 231, 241 are PNP transistors, and the second, third, fifth and sixth transistors 232, 233, 242, 243 are NPN transistors in this embodiment.

The processor 26 detects a voltage drop at the junction of the drive unit 22 and the voltage drop component 25 via the detecting terminal 261, provides a first pulse-width-modulated (PWM) signal (G) to the third transistor 233 of the first transistor unit 23 via the first output terminal 262, and simultaneously provides a second PWM signal (H) to the sixth transistor 243 of the second transistor unit 24 via the second output terminal 263. The second PWM signal (H) is an inverted form of the first PWM signal (G). The processor 26 provides the first and second PWM signals (G), (H) to cause the first and second transistor units 23, 24 to operate in the conducting and non-conducting states in an alternating manner according to change in the voltage drop detected at the junction of the drive unit 22 and the voltage drop component 25 in order to avoid erroneous operation of the first and second transistor units 23, 24 due to back electromotive force occurring at the instant the direction of current flow through the drive coil 221 is switched.

In particular, when the first PWM signal (G) at the first output terminal 262 of the processor 26 is at a high logic state such that the first transistor unit 23 is at the conducting state, and the second PWM signal (H) at the second output terminal 263 of the processor 26 is at a low logic state such that the second transistor unit 24 is at the non-conducting state, electric current flows through the drive coil 221 in the direction indicated by the solid arrow line in FIG. 3 and then to the voltage drop component 25 to result in a voltage drop thereat. The processor 26 detects the voltage drop at the junction of the drive unit 22 and the voltage drop component 25 via the detecting terminal 261, causes the first PWM signal (G) at the first output terminal 262 of the processor 26 to change to the low logic state such that the first transistor unit 23 switches to the non-conducting state, and further causes the second PWM signal (H) at the second output terminal 263 of the processor 26 to change to the high logic state such that the second transistor unit 24 is at the conducting state, there by resulting in the flow of electric current through the drive coil 221 in the direction indicated by the dotted arrow line in FIG. 3 and then to the voltage drop component 25 to result in a voltage drop thereat. The processor 26 detects the voltage drop at the junction of the drive unit 22 and the voltage drop component 25 via the detecting terminal 261, causes the first PWM signal (G) at the first output terminal 262 of the processor 26 to change to the high logic state such that the first transistor unit 23 switches to the conducting state, and further causes the second PWM signal (H) at the second output terminal 263 of the processor 26 to change to the low logic state such that the second transistor unit 24 is at the non-conducting state. Hence, the processor 26 provides the first and second PWM signals (G), (H) to cause the first and second transistor units 23, 24 to operate in the conducting and non-conducting states in an alternating manner according to the change in the voltage drop detected at the junction of the drive unit 22 and the voltage drop component 25.

Therefore, when the motor controller 2 of this invention is applied to adjust the speed of the rotor of the brushless direct current motor, the detecting terminal 261 of the processor 26 is used to continuously monitor whether there is current flowing through the voltage drop component 25. When electric current flows through the voltage drop component 25, the processor 26 responds to the detected voltage drop by reversing the logic states of the first and second PWM signals (G), (H). As such, the first and second transistor units 23, 24 are driven to operate in the conducting and non-conducting states in an alternating manner with precision and smoothness at the required frequency, without being affected by the back electromotive force occurring at the instant the direction of current flow through the drive coil 221 is switched, so that the direction of current flow through the drive coil 221 can be switched with precision, thereby achieving the effects of good rotation stability and highly precise speed control.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A motor controller comprising:
a power source unit for providing a direct current output;
a drive unit including a drive coil;
first and second transistor units coupled electrically to said power source unit and said drive unit, and enabling electric current to flow through said drive coil in a first direction when said first transistor unit is in a conducting state and said second transistor unit is in a non-conducting state, and in a second direction opposite to the first direction when said second transistor unit is in a conducting state and said first transistor unit is in a non-conducting state;
a voltage drop component having a first end coupled electrically to said drive unit and a grounded second end; and
a processor having a detecting terminal coupled electrically to a junction of said drive unit and said voltage drop component, a first output terminal coupled electrically to said first transistor unit, and a second output terminal coupled electrically to said second transistor unit,
said processor detecting a voltage drop at said junction via said detecting terminal, providing a first pulse-width-modulated signal to said first transistor unit via said first output terminal, and simultaneously providing a second pulse-width-modulated signal to said second transistor unit via said second output terminal, the second pulse-width-modulated signal being an inverted form of the first pulse-width-modulated signal, said processor providing the first and second pulse-width-modulated signals to cause said first and second transistor units to operate in the conducting and non-conducting states in an alternating manner according to change in the voltage drop detected at said junction.

2. The motor controller as claimed in claim 1, wherein said voltage drop component is a resistor.

3. The motor controller as claimed in claim 1, wherein said drive unit includes a first set of diodes that are coupled electrically and respectively between opposite ends of said drive coil and said power source unit, and a second set of diodes that are coupled electrically and respectively between said opposite ends of said drive coil and said voltage drop component.

4. The motor controller as claimed in claim 1, wherein:
said first transistor unit includes a first transistor coupled between said power source unit and a first end of said drive coil, a second transistor coupled between said voltage drop component and a second end of said drive coil, and a third transistor coupled between said first and second transistors and further coupled to said first output terminal; and
said second transistor unit includes a fourth transistor coupled between said power source unit and said second end of said drive coil, a fifth transistor coupled between said voltage drop component and said first end of said drive coil, and a sixth transistor coupled between said fourth and fifth transistors and further coupled to said second output terminal.

5. The motor controller as claimed in claim 4, wherein said first and fourth transistors are PNP transistors, and said second, third, fifth and sixth transistors are NPN transistors.
